(19) United States
(12) Patent Application Publication
(10) Pub. No.: US 2004/0205256 A1
(43) Pub. Date: Oct. 14, 2004

(54) System and method for communicating between two or more locations

(76) Inventors: Richard Hoffman, Lake Forest, IL (US); Jay Kukoff, Warren, NJ (US)

Correspondence Address: Wallenstein Wagner & Rockey, Ltd., 53rd Floor, 311 S. Wacker Drive, Chicago, IL, 60606-6630, US

(21) Appl. No.: 10/723,452

(22) Filed: Nov. 26, 2003

Related U.S. Application Data
(60) Provisional application No. 60/429,578, filed on Nov. 27, 2002.

(51) Int. Cl. G06F 3/00; G06F 15/16

(52) U.S. Cl. 710/1; 709/201

(57) ABSTRACT

A system and method for communicating between two or more locations is provided in which a person at a first location (100) wears a device (205) which transmits audiovisual information to a second person at a remote second location (103), and thus enables the second person to see and hear the environment witnessed by the first user. The device (205) may also receive audiovisual information from the second person so as to enable communication and instruction from the second person to the first person. A recording device (219) may also be used for recording audiovisual transmissions sent between the two locations.

### CROSS-REFERENCE TO RELATED APPLICATIONS

This application claims priority from Provisional Patent Application Serial No. 60/429,578, filed Nov. 27, 2002.

### FIELD OF THE INVENTION

The present invention relates generally to a virtual technician, and more particularly, to a system and method for a person at a first location to assist a second person at a second, remote location in reviewing and repairing equipment located at the remote location.

### BACKGROUND OF THE INVENTION

Service providers of various types are often required by customers to provide service at the customer's location. For example, computer technicians often travel from their “home” office to the customer's location to provide technical support for the customer's equipment. The manufacturer of factory equipment may be required by its customer to send a technician to the factory location to service such equipment. In a marketplace of increasingly complex machinery and increasingly complex computer software, agreements between manufacturers/producers and their customers to provide on-site service are becoming increasingly common.

Some service providers attempt to solve customer problems through telephone communications. Typically, a customer calls the service provider and speaks with a technician, who attempts to understand from information provided by the customer the source and solution to the particular customer problem. However, customers frequently lack enough skill or expertise in completely understanding the service provided by the service provider. For example, a typical home computer user is not experienced in diagnosing or fixing a complicated computer hardware problem. Thus, service providers are extremely limited in their ability to provide support over a telephone, as they must rely on the customer's untrained description of the problem. Frequently, such service problems can be solved much more quickly by the service provider if the provider were actually physically present at the site of the problem.

In certain service industries, the customer's limited knowledge of the service, device, or equipment can also lead to extremely cost- and time-consuming delays. For example, a worker at a factory may be unable to accurately diagnose a problem to a remote service support technician; the problem may lead to a costly delay in production at the factory while the worker waits for the physical arrival of the technician. Moreover, in certain service industries, the customer's inability to accurately describe or diagnose a problem may indeed prove dangerous.

The present invention is provided to solve these and other problems.

### SUMMARY OF THE INVENTION

The present invention provides a virtual technician system in which a first user at a first location may receive remote technical assistance from a second user at a second location. The system utilizes an audiovisual device owned by the first user which displays audiovisual information to the second user, and thus provides invaluable “eyes and ears” to the second user to aid in diagnosing and repairing a technical problem. Remote assistance system of this type significantly reduces or eliminates the need for costly on-site technical assistance.

A system for providing remote technical assistance is disclosed in which a first user wears a camera or a microphone. The device includes a microprocessor, which receives audiovisual information from the camera and/or microphone and transmits that data to the second user. The data may be captured and stored in a memory for later transmission to the second user, or it may be transmitted immediately to the second user to enable real-time support. The device worn by the first user may also include another audiovisual device to enable instruction from the second user.

In another embodiment of the present invention, the device worn by the first user is a pair of eyeglasses in which a camera and/or microphone is built into the eyeglasses. A microprocessor attached to the eyeglasses receives information from the camera and/or microphone and transmits that data to the second user. The second user receives and views the data with a computer or other audiovisual reception device and is thus able to see and/or hear the problems witnessed and reported by the first user.

In yet another embodiment of the present invention, the audiovisual recording device is a camera and/or microphone positioned to provide a view to the second user of the problems witnesses by the first user. The device may provide data to the second user only when necessary, i.e., only in the event of a problem, or may provide constant data transmission to the second user and thus enable the second user to anticipate a service problem.

Other features and advantages of the invention will be apparent from the following specification taken in conjunction with the following drawings.

### BRIEF DESCRIPTION OF THE DRAWINGS

FIG. 1 is a block diagram of the system and method for communicating between two locations and illustrating the interaction between users and flow of data in the system;

FIG. 2 is a block diagram of a portion of the system and method for communicating between two locations and illustrating the audiovisual device and its connections, to be used by a user at a first location and transmitting data to a second location; and,

FIG. 3 is a block diagram of a portion of the system and method for communicating between two locations and illustrating the computer and its connections, to be used by a user who is receiving audiovisual data from another user at a remote location.

### DETAILED DESCRIPTION

While this invention is susceptible to embodiment in many different forms, there are shown in the drawings and herein described in detail preferred embodiments with the understanding that the present disclosure is to be considered an exemplification of the principles of the invention and is not intended to limit the broad aspects of the invention to the embodiments illustrated.

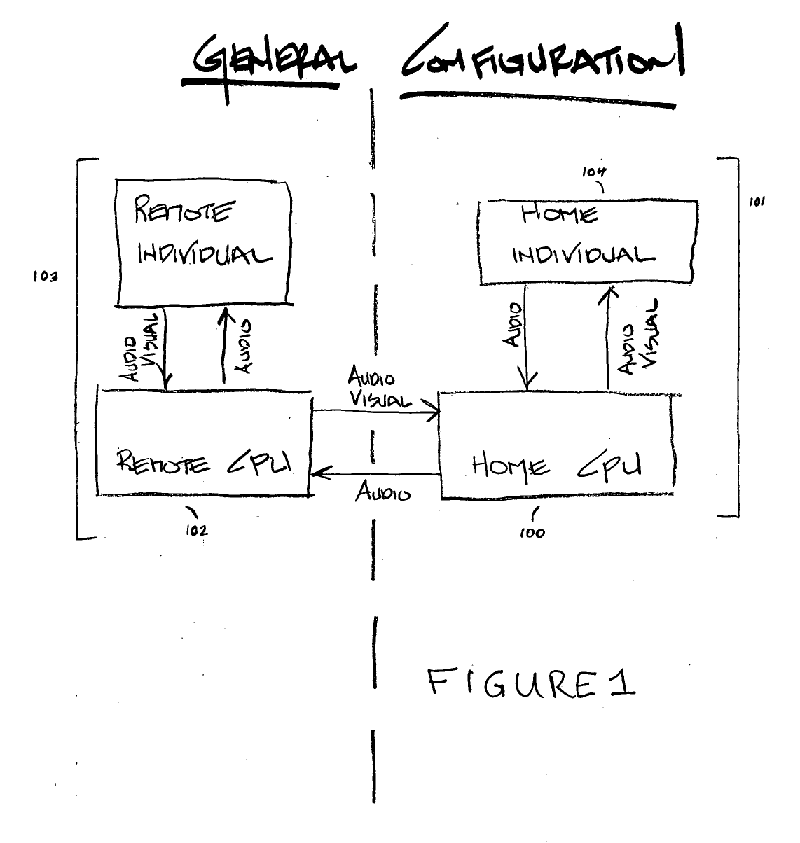

Referring in detail to the drawings and initially to FIG. 1, there is provided a system and method for communicating between a first and second location. A first processor 100 is provided at a first location 101, and a second processor 102 is provided at a second location 103. In one embodiment of the present invention, a user 104 operates the first processor 100 at the first location 101. In another embodiment of the present invention, there is no user 104 at the first location 101, and instead data is transmitted automatically from the first location 101 without user assistance or direction.

Audiovisual data is transmitted from the first processor 100 to the second processor 102. The audiovisual data includes visually-displayed data, such as a live or recorded camera feed. The audiovisual data may also include audio data, such as a live or recorded audio feed from a microphone. The data can be both audio and visual data simultaneously streaming, further equipped to allow for selective transmission of either audio or video data.

The communication between the first processor 100 and the second processor 102 may be concurrent or disjoint. In a concurrent arrangement, data is received by the first processor 100 and transmitted immediately to the second processor 102. In a disjoint arrangement, data is received by the first processor 100 and stored for later transmission to the second processor 102.

The transmission between the first processor 100 and the second processor 102 may also be temporary or permanent. In a temporary arrangement, the communication between the processors 100 and 102 is established for a necessary period of time, and is then terminated. For example, the user operating the first processor 100 may open communication with the second processor 102 in response to a technical problem at the first location 101. The communication with the second processor remains open for as long as data transmission is necessary, and is eventually severed.

Alternatively, in a permanent arrangement, the communication between first and second processors 100 and 102 is established once and remains open indefinitely. For example, a user operating the first processor 100 may establish communication with the second processor 102 in anticipation of a problem at the first location 101. As another example, the user operating the second processor 102 may establish communication with the first processor 100 for the purpose of monitoring the first location 101.

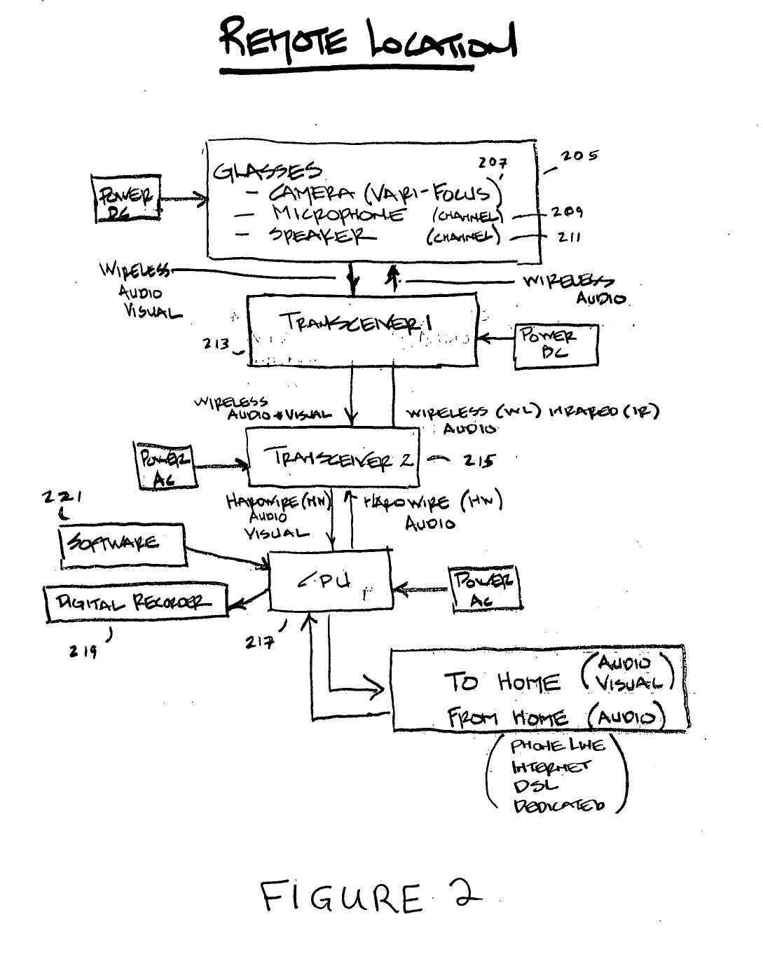

Referring now to FIG. 2, there is provided a device 205 which is worn by a user operating the first processor 100. The device comprises a camera 207, which can be either a digital or an analog camera. Preferably, the camera 207 is digital, so as to enable real-time transmission of video data to the second processor 102. The camera 207 may be equipped with manually-operated zoom, so as to enable the user of the camera 207 to magnify the image captured by the camera 207, or may be equipped with automatic zoom, so as to enable automatic focusing and image enhancement without user assistance or direction. The camera 207 is preferably small, so as to enable comfortable wear by the user of the device 205. Suitable dimensions of a camera 207 in accordance with the present invention are 40 mm wide by 40 mm tall by 35 mm length, with a weight of approximately 2.5 ounces. A standard one-third inch micro-camera lens is preferable, although a camera lens of much smaller dimensions, for example, a fiber optic camera, is also operable with the present invention. Preferably, the camera 207 transmits a standard digital video format such as NTSC 510×492 resolution at 525 lines per image captured. The interlace video output on the camera 207 is a standard 2 Vp-p at 75 Ohm, with a 2:1 aspect ratio and an automatic shutter operating at 1/60 to 1/15,000 sec. Preferably, the camera 207 has an optional gamma correction feature, which may be turned on/off by the user. The power supply of the camera 207 is a standard 8-12 DC volts, with a power requirement of 40 mA at a 12 DC volt input. To accommodate the wide range of applications for the present invention, the camera 207 preferably has operating capacity within an environment ranging from −10° Celsius to +55° Celsius, with a tolerance range of 0-95% humidity. The camera 207 is preferably digital, and may transmit data in a standard digital format such as NTSC 510×492 resolution at 525 lines per image captured. Alternatively, the camera 207 may be of proprietary and non-standard design so as to enable lesser or greater image enhancement.

The device 205 may be incorporated into eyewear worn by the user operating the device 205. The device 205 may thus be embodied in a pair of eyeglasses wherein the camera 207 is mounted on the eyeglasses. Alternatively, the device 205 may be a monocular device worn over the eye of the user, or may be built into a hat or helmet worn by the user.

The device 205 may also comprise a microphone 209. Like the camera 207, the microphone 209 is preferably small so as to be comfortably worn by the user of the device 205. A 0.25 inch or 0.12 inch microphone adapter may be used, though both smaller and larger microphone dimensions are operable within the scope of the present invention. The microphone 209 has an operating power supply range of 8 DC volts to 12 DC volts. To accommodate the wide range of applications for the present invention, the microphone 209 preferably has a maximum audio output of 800 mW, operating capacity within an environment ranging between −10° Celsius to +55° Celsius, with a tolerance range of 0-95% humidity. Further, the microphone 209 may be voice-operated, so as to provide for automatic power-on and operation when sound is received by the microphone 209. Both the camera 207 and the microphone 209 can be user-controlled such that the user of the device 205 may selectively turn the camera 207 and microphone 209 on or off and thus selectively control the audiovisual transmission to the second processor 102.

The device 205 also comprises a speaker 211. Audiovisual data may be received by the device 205, and this data may be transmitted to the user of the device 205 via the speaker 211. Preferably, the speaker 211 has a range of 0-12 Ohm, and is operably connected to the device 205 housing so as to enable the simultaneous transmission and reception of audiovisual data by the user of the device 205. For example, a user may transmit audiovisual data to a user operating the second processor 102, yet simultaneously receive sound data from that user via the speaker 211. The device 205 therefore enables the user operating the second processor 102 to see and hear the environment witnessed by the user of the first processor 100, and simultaneously enables that user to hear instruction from the user operating the second processor 102.

The device 205 is connected to a power supply. The power supply may be a standard commercially-available 8 DC to 12 DC volt electrical plug. So as to enable the full freedom of motion of the user of the device 205, the power supply is preferably a 8 DC volt to 12 DC volt battery connected to the device 205 and worn by the user.

The device 205 is connected to a transceiver 213, which transmits audiovisual data from the device 205 and its components to the first processor 100. The transceiver frequency is preferably 2.4 GHz, but transceivers of lesser frequency, for example 900 Mhz, are operable within the parameters of the present invention. The transceiver 213 is preferably a multi-channel transceiver with automatic channel selection and/or user-based channel selection, although a single-channel transceiver is operable with the present invention. To enable the full advantages of the present invention, the transceiver 213 is preferred to have a range of at least 1000 feet from the first processor 100, with a reception sensitivity of −85 dBm. The transmitter antenna of the transceiver 213 preferably is preferably an omni non-directional antenna, though directional antennas—both automatic and user-operated—are operable with the transceiver 213 of the present invention. The power output of the transceiver is preferably a 100 mW modulation, while the transceiver 213 requires a standard power supply of 8 DC volts to 12 DC volts. The transceiver 213 has a power consumption of 925 mA at a 12 DC volt power input, and the transmitting portion of the transceiver 213 has a power consumption of 290 mA at a 12 DC volt power input.

The audiovisual data transmitted by the transceiver 213 is received by a second transceiver 215. Preferably, so as to provide for the highest degree of transmission quality, the two transceivers 213 and 215 are identical to each other in dimensions and hardware, although two different types of receivers 213 and 215 may still be used in accordance with the principles of the present invention. The transmission between the first transceiver 213 and the second transceiver 215 may be concurrent or disjoint, and may be via a wired or wireless communications protocol. Additionally, the transmission may be via the Internet, though a communications protocol as Transfer Control Protocol of Uniform Data Protocol.

The audiovisual data is received at the second transceiver 215 which is operably connected to a second processor 217. Preferably, the second processor 217 is equipped to operate software 221. The software 221 enables the audiovisual data to be displayed to a user operating the second processor 217. The software 221 may be a proprietary program, or may be a commercially-available audiovisual communications program such as Microsoft NetMeeting. The second processor 217 is preferably part of a computer system. The system preferably has a capacity for at least eight simultaneous audiovisual transmission data streams to be received by the second processor 217, although the reception of only one audiovisual data stream is in accordance with the present invention. The computer driven by the second processor 217 preferably has full-frame video capture capability at NTSC 640×480 resolution at between 1 and 40 frames per second.

The second processor 217 is preferably also in communication with a recording device 219 so as to enable recording the audiovisual transmission for storage. The recording device 219 can be a commercially-available standard audiovisual cassette, digital audio tape, or digital memory storage device. Preferably, the recording device 219 is a digital random- or sequential-access memory with a storage capacity between 25 MB and 55 TB.

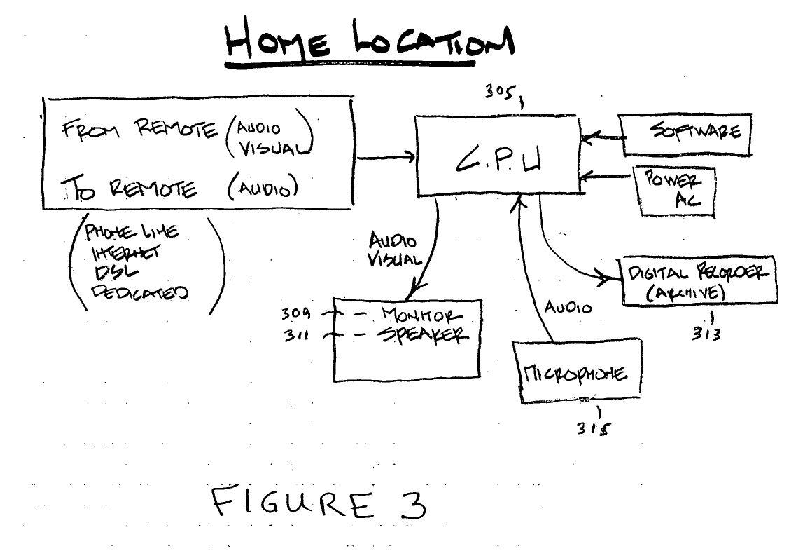

Referring now to FIG. 3, there is provided a system to receive communication from a remote location 101. A processor 305 is provided to receive audiovisual data from a transceiver 215. The data is transmitted from the processor 305 to a display 309. The display 309 may be a standard computer monitor, or may be a digital display such as the type used on a personal communications device such as a cellular phone or personal data assistant. The data may also be transmitted from the processor 305 to a speaker 311, so as to enable the user of the processor 305 to see and hear the environment experienced by a user at the first location 101. The processor 305 may also be in communication with a microphone 315, or a camera, or both, so as to enable the transmission of audiovisual data to a user at the first location 101. The processor 305 may also be in communication with a recording device 313, so as to enable the recording and archiving of audiovisual data sent or received, or both, between the two locations 101 and 103.

The principles of the present invention are practicable in a wide range of personal, commercial, and industrial embodiments. For example, the system may be used to remotely assist in machinery repairs. An individual at a machinery site, e.g., a factory or shop, can transmit audiovisual information relating to machinery repairs to a remote location where a qualified expert can transmit back instructions regarding the repairs needed. Also, a person at a manufacturing site can transmit audiovisual data relating to a broken manufacturing process to a technician at a remote location for assistance. Another embodiment of the invention in a machinery environment allows mechanics to transmit audiovisual data to customers at a remote location so as to enable the customers to monitor the progress of construction or repair.

In a warehouse or storage management environment, the principles of the present invention can be used to relay audiovisual information to another individual at a remote location regarding supplies or inventories. Persons at the warehouse or storage location can record and verify volumes of inventory without the need to carry cumbersome recording devices.

In an advertising or sales environment, the principles of the present invention can be used to remotely advertise and sell products to people at remote locations. For example, a real estate agent can wear the device 205 to show a house to potential buyers who are at a remote location, who in turn can use the invention to instruct the real estate agent regarding the showing of the property. A salesperson can show a product to prospective purchasers at a remote location, who can in turn instruct the sales associate on showing the product.

In a construction or development environment, the principles of the present invention can be used to remotely monitor and instruct the construction or development. For example, a construction worker wearing or using the device 205 can transmit audiovisual information to an engineer, architect, or contractor at a remote location. The engineer, architect, or contract can in turn use the invention to instruct the construction worker regarding the development of the construction. Instructions regarding specific features to be added, removed, or modified can be relayed remotely. Building inspections can be accomplished from a remote location. Construction work can be documented and verified for the benefit of a prospective purchaser.

In a medical operations or hospital environment, the principles of the present invention can be used to remotely provide medical advice or observations. A doctor or patient can use or wear the device 205 to transmit audiovisual information to a doctor at a remote location. The remotely located doctor can in turn provide advice or instruction via the invention. Surgeons at a remote location can be monitored and assisted my medical specialists at a remote location. Surgical or other medical data can be recorded for use in later analysis, research, or investigation. A paramedic using or wearing the device 205 can transmit audiovisual information to a remotely-located doctor or other medical personnel, who can in turn provide instruction to the paramedic regarding on-site medical care.

In an educational environment, the principles of the present invention can be applied to assist in remote teaching or instruction. A teacher or student wearing or using the device 205 can transmit audiovisual information to a teacher or pupil at a remote location. The remotely-located teacher or pupil can in turn provide commentary, as questions, or provide instruction via the invention. A university employee wearing or using the device 205 can provide a tour of a university campus to prospective students at remote locations. A remotely-located teacher or other instructor can provide direction to students at another location.

In a military or paramilitary environment, the principles of the present invention can be applied to assist in training, combat, or espionage. Soldiers wearing or using the device 205 can transmit audiovisual information to a remotely-located instructor or officer, who can in turn provide instruction to the soldier. The information can be recorded and saved for later analysis. Soldiers and officers can use the invention to relay precise information relating to their environment, and can receive orders and other information from the remotely-located recipient of their information.

In a space environment, the principles of the present invention can be applied to assist astronauts in performing repair work to spacecraft or in planetary observation. The astronaut using or wearing the device 205 can transmit audiovisual information to a remote location, where other personnel can provide commentary and instruction to the astronaut. The audiovisual transmission can be recorded and stored for later analysis.

In an insurance environment, the principles of the present invention can be applied to assist investigators in determining the validity of insurance claims. A claimant or investigator wearing or using the device 205 can record the scene of an accident or other damage for later analysis regarding insurance claims.

In an employment environment, the principles of the present invention can be applied to conduct long-distance employment interviews. A prospective employee wearing or using the device 205 can transmit audiovisual information to a prospective employer, who may in turn provide commentary or ask questions of the potential employee via the invention. A potential employee may use the invention to demonstrate skills to a potential employer. A prospective employer may provide a prospective employee a long-distance tour of the employer's facilities or office.

In a corporate environment, the principles of the present invention can be applied to assist corporate managers in receiving timely information about the corporation. A corporate employee using or wearing the device 205 can transmit audiovisual information to the corporate manager with information requisite to a decision by the manager, who in turn can provide commentary and ask questions of the transmitting user.

In a legal environment, the principles of the present invention can be applied to assist attorneys and other legal employees in conducting legal business. A deponent using or wearing the device 205 can transmit audiovisual information to a deposing attorney at a remote location, who can in turn observe an environment and ask questions of the deponent. The information can be recorded and stored for later analysis and review. Live audiovisual testimonies of witnesses can be taken who are located at remote locations via the invention. Attorneys at one location can discuss particular exhibits with attorneys in another location via the invention.

In a child-care environment, the principles of the present invention can be used to assist in child monitoring at a remote location. A daycare provider or using or wearing the device 205 can transmit audiovisual information to a remotely-located parent, who can observe the child in its real-time environment via the invention, and in turn ask questions or provide commentary to the daycare provider.

In a security environment, the principles of the present invention can be used to maintain or enhance the security of a facility. A security officer wearing or using the device 205 can transmit audiovisual information to another person, who can in turn verify the identity of a third person being viewed with the device by the security officer. The audiovisual information can be recorded and stored for future use as a record of visitors to the facility.

In a law enforcement environment, the principles of the present invention can be used to assist law enforcement officers in investigations. A law enforcement officer using or wearing the device 205 can transmit audiovisual information to a remotely-located forensic investigator, who can in turn provide instruction to the law enforcement officer regarding the investigation scene. A law enforcement officer using or wearing the device 205 can transmit audiovisual information to a remotely-located law enforcement office, where personnel there may transmit information back to the law enforcement officer regarding facts concerning the environment in which the law enforcement officer is located. The audiovisual information can be recorded and stored for future use as evidence.

In an agricultural environment, the principles of the present invention can be used to assist growers in examining and analyzing crops. A grower wearing or using the device 205 can transmit audiovisual information to a remotely-located scientist or expert, who can in turn provide information to the grower regarding crop production and status.

It will be understood that the invention may be embodied in other specific forms without departing from the spirit or central characteristics thereof. The present embodiments, therefore, are to be considered in all respects as illustrative and not restrictive, and the invention is not to be limited to the details given herein.

What is claimed is:

1. A system for communicating between a first and second location, comprising:
a first processor at a first location and in communication with a second processor at a second location; and,
an audiovisual recording device in communication with the first processor and comprising at least one of a camera and a microphone.

2. The system of claim 1, wherein the audiovisual device is worn by a user.

3. The system of claim 1, wherein the audiovisual device comprises a device worn over the eyes of a user.

4. The system of claim 1, further comprising a memory in communication with the first processor for storing data received by the audiovisual device.

5. The system of claim 1, further comprising a second audiovisual device in communication with the first processor for receiving audiovisual data from the second processor.

6. The system of claim 1, wherein the communication between the audiovisual device and the first processor is a wireless communication.

7. A method for communicating data between a first and second location, comprising the steps of:
providing for, at a first processor at a first location, receiving audiovisual data from an audiovisual device comprising at least one of a camera and a microphone; and,
providing for transmitting the audiovisual data to a second processor at a second location.

8. The method of claim 7, wherein the audiovisual device is a device worn by a user.

9. The method of claim 7, wherein the audiovisual device comprises a device worn over the eyes of a user.

10. The method of claim 7, further comprising the step of:
providing for storing the audiovisual data in a memory, the memory being in communication with the first processor.

11. The method of claim 7, further comprising the step of:
providing for, at the first processor, receiving audiovisual data from the second processor.

12. The method of claim 7, wherein the communication between the audiovisual device and the first processor is a wireless communication.

13. A system for communicating between a first and second location, comprising:
a first processor at a first location for executing an application; and,
a memory in communication with the processor;
wherein the application comprises:
a first code segment for receiving audiovisual data from an audiovisual device, wherein the audiovisual device comprises at least one of a camera and a microphone; and,
a second code segment for transmitting the audiovisual data to a second processor at a second location.

14. The system of claim 13, wherein the audiovisual device is worn by a user.

15. The system of claim 13, wherein the audiovisual device comprises a device worn over the eyes of a user.

16. The system of claim 13, wherein the application further comprises:
a third code segment for storing the audiovisual data in a memory, the memory in communication with the first processor.

17. The system of claim 13, wherein the application further comprises:
a third code segment for receiving audiovisual data from the second processor.

18. The system of claim 13, wherein the communication between the audiovisual device and the first processor is a wireless communication.

19. A system for communicating between a first and second location, comprising:
a first processor at a first location for executing an application; and,
a memory in communication with the processor;
wherein the application comprises:
a first code segment for receiving audiovisual data from a second processor at a second location, wherein the second processor is in communication with an audiovisual device, the audiovisual device comprising at least one of a camera and a microphone.

20. The system of claim 19, wherein the audiovisual device is worn by a user.

21. The system of claim 19, wherein the audiovisual device comprises a device worn over the eyes of a user.

22. The system of claim 19, wherein the application further comprises:
a second code segment for receiving data from a second audiovisual device, wherein the second audiovisual device is in communication with the first processor.

23. The system of claim 19, wherein the application further comprises:
a third code segment for transmitting data received from the second audiovisual device to the second processor.

24. The system of claim 19, wherein the communication between the audiovisual device and the first processor is a wireless communication.

25. A method for communicating between a first and second location, comprising:
providing for, from a first location, transmitting audio and visual information to a person at a second location;
providing for, from the second location, transmitting audio information to a person at the first location.

26. The method of claim 25, further comprising:
providing for, from the second location, transmitting video information to a person at the first location.

27. The method of claim 25, further comprising:
providing for storing the audio and video information transmitted between the first and second locations in a retrievable storage device.

28. The method of claim 25, wherein an audiovisual device is positioned about the head of the first person at the first location.

29. A method of providing instruction between two persons, comprising:
providing for, at a first location, a first person transmitting audio and visual information to a second person at a second location;
providing for, at the second location, transmitting information comprising an instruction to the first person at the first location.

30. The method of claim 29, further comprising:
providing for, from the second location, transmitting video information to the first person at the first location.

31. The method of claim 29, further comprising:
providing for storing the audio and video information transmitted between the first and second locations in a retrievable storage device.

32. The method of claim 29, wherein an audiovisual device is positioned about the head of the first person at the first location.

33. A method of remote communication, comprising:
a first user at a first location;
an audiovisual device positioned about the head of the first person;
a transceiver operably connected to the audiovisual device at the first location;
a second user at a second location;
an audiovisual receptive device at the second location;
a transceiver operably connected to the audiovisual reception device at the second location;
transmitting audiovisual information from the transceiver at the first location to the transceiver at the second location; and,
transmitting audio-only information from the transceiver at the second location to the transceiver at the first location.

34. A system for communicating between a first and second location, comprising:
a first processor at a first location;
a first audiovisual device comprising a camera and microphone worn by over the eyes of a user and in communication with the first processor;
a first transceiver operably connected to the first audiovisual device and for transmitting audiovisual information captured by the first audiovisual device;
a second processor at a second location;
a second audiovisual device in communication with the second processor and for viewing audiovisual information captured by the first audiovisual device;
a second transceiver operably connected to the second audiovisual device and for receiving audiovisual information from the first transceiver; and,
a memory in communication in communication with the second processor and for retrievably storing audiovisual information received from the first transceiver.
